(19) United States
(12) Patent Application Publication
(10) Pub. No.: US 2017/0247984 A1
(43) Pub. Date: Aug. 31, 2017

(54) WEAK LINK ARRANGEMENT AND A METHOD COMPRISES A WEAK LINK ARRANGEMENT

(71) Applicant: Aker Solutions AS, Lysaker (NO)

(72) Inventors: Bjørn PAULSHUS, Kjeller (NO); Sigvard OMVIK, Moss (NO)

(73) Assignee: Aker Solutions AS, Lysaker (NO)

(21) Appl. No.: 15/516,569

(22) PCT Filed: Oct. 15, 2015
(86) PCT No.: PCT/NO2015/050191

§ 371 Date: Apr. 3, 2017

(30) Foreign Application Priority Data
Oct. 17, 2014 (NO) 20141245

(51) Int. Cl. E21B 41/00; F16L 55/10

(52) U.S. Cl. CPC E21B 41/0021; E21B 41/0007; F16L 55/1007

(57) ABSTRACT

A weak link arrangement (1) designed for location on an umbilical (6, 7) extending on the seabed between respective structures potentially subjected to environmental hazards, like being snapped by an iceberg, which umbilical includes communicating fluid pipes and electric cables, is described. The weak link arrangement (1) includes a seabed frame (2) supporting an umbilical having a weak link multiconnecting structure (3) (UTA) installed in line, which weak link multiconnecting structure (3) (UTA) ensures continuous communication through the fluid pipes and electric cables until emergency disconnection takes place. Such disconnection is initiated by accidental pull in the umbilical, which pull activates disconnecting means and cable severing means.

The present invention relate to a weak link system arranged in one end of an umbilical in order to protect a platform and an umbilical termination assembly from damage in case of emergency disconnect, like an umbilical is snapped by an iceberg, trawler board or any accidental case.

For umbilical systems located in areas exposed to icebergs, the potential for damage exists both to the platform structure and the subsea equipment in the event an iceberg snags or drags the umbilical. In order to eliminate or reduce the negative effects of this potential hazard, a weak link arrangement is introduced into the umbilical line on the seabed.

The present invention represents an in-line weak link concept as a 3-step system. The 3 weak link mechanisms are as follows:
1. UTA (Umbilical Termination Assembly) to foundation structure weak link mechanism is a shear pin system designed to break at a certain load, i.e. 40 tonnes (an example only).
2. The hydraulics are held together by a clamp connector that is released once the shear pin is triggered.
3. The electrical cables are cut by a passive guillotine located inside the UTA, once the UTH-hub (Umbilical Termination Head) is separated from the UTA-hub.

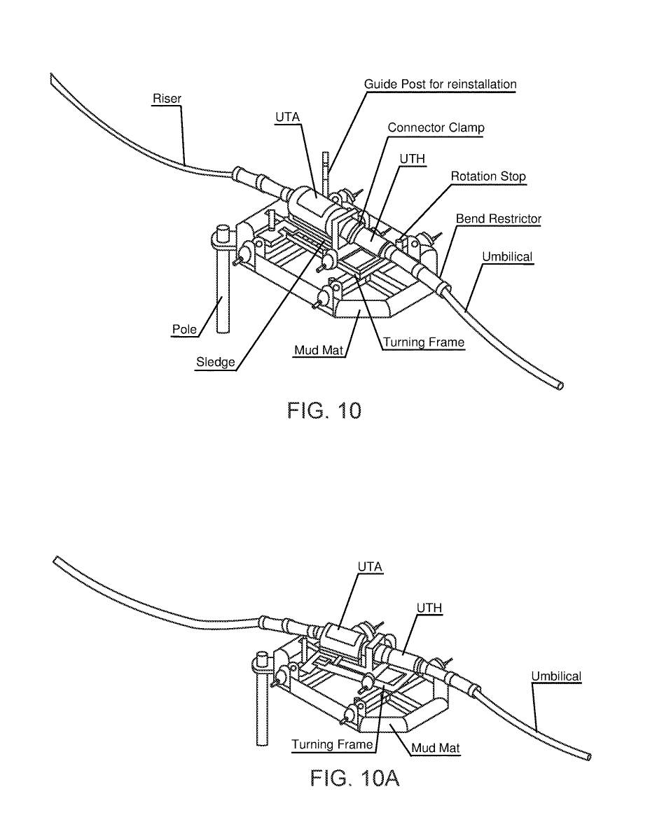

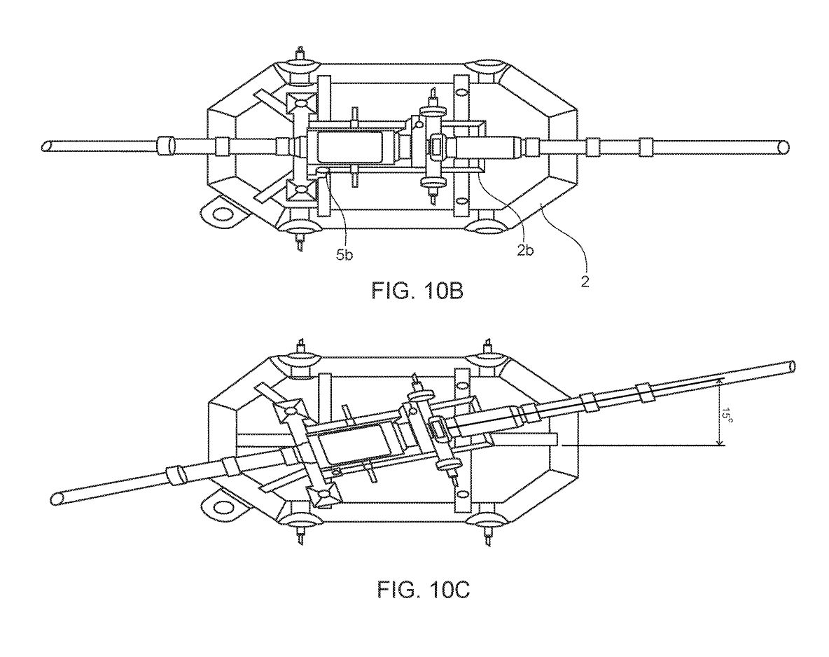

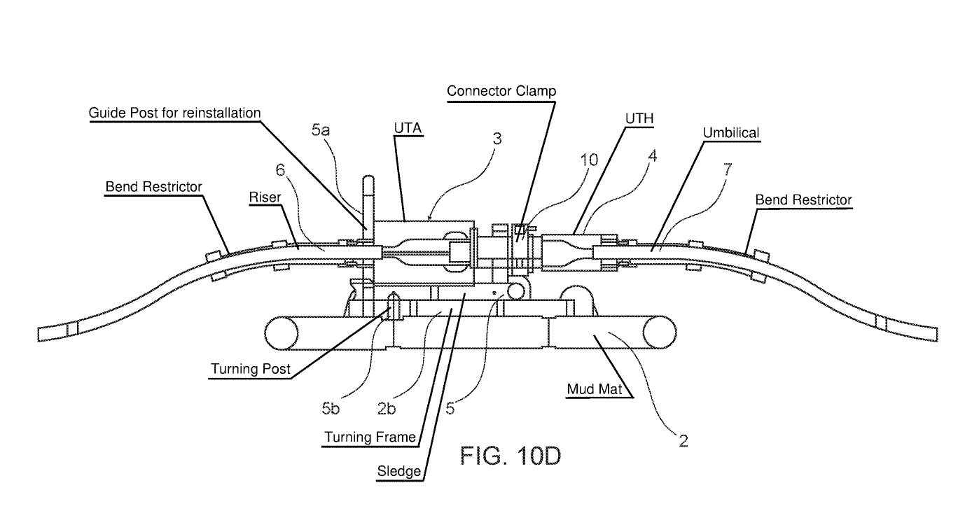

If subjected to an iceberg, the system is designed to be triggered at 40 tonnes tension, without this figure being a limitation, just an indicative example. The tension is being caused by the iceberg dragging the umbilical with it when moving along the seabed. At first, this will cause a bending moment on the seabed structures that both ends of the umbilical are attached to. The weak link system is designed such that the bending loads are transferred to tension loads through a rotational feature in the system (see FIG. 10).

When the tension loads reach a level of 40 tonnes, the first step in the weak link system is triggered. This is a shear pin system between the UTA and the foundation structure. The shear pin is designed to break at 40 tonnes which will allow the UTA-frame to slide along the foundation structure for a distance of about 200 mm (example only).

During those 200 mm of travel, the clamp connector holding the two hubs together will be opened and will fall down, and the hubs are free to separate.

When the UTH-hub starts to remove itself from the UTA-hub, the electrical cables, which go straight through both hubs and are terminated inside the UTA, will tighten and be forced over the passive guillotine which severs them. The infield portion of the umbilical is then free to move along with the iceberg with all the other subsea equipment left unharmed.

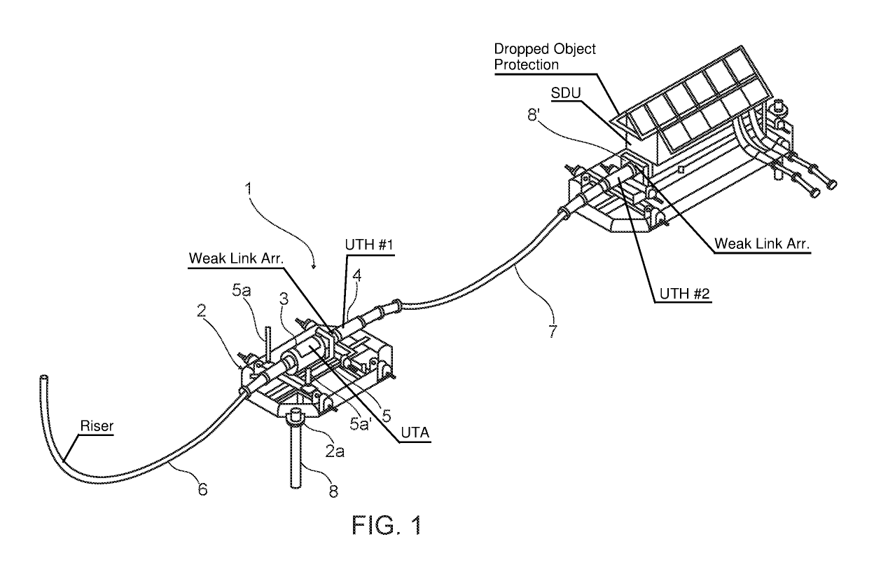

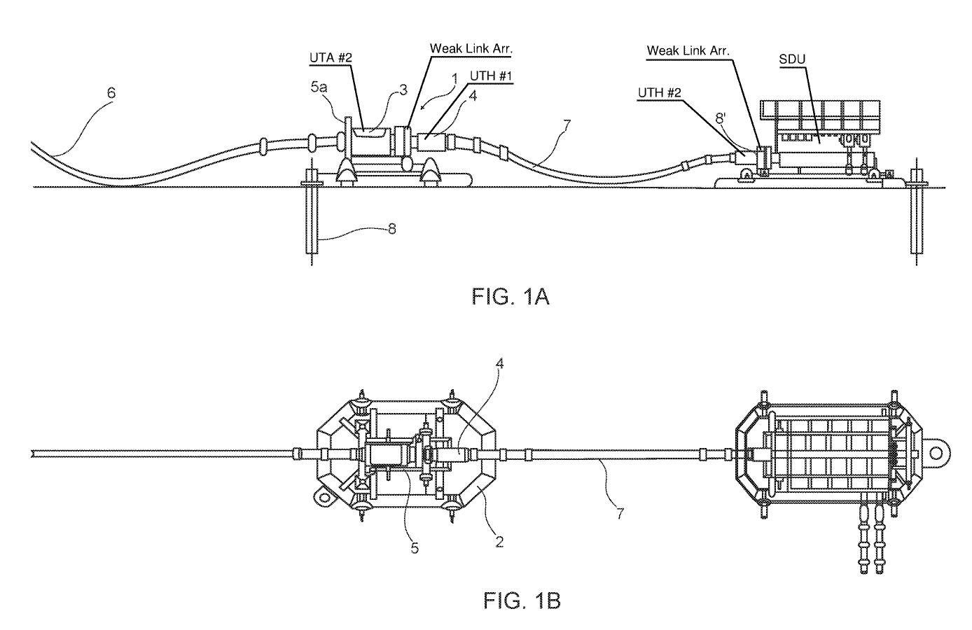

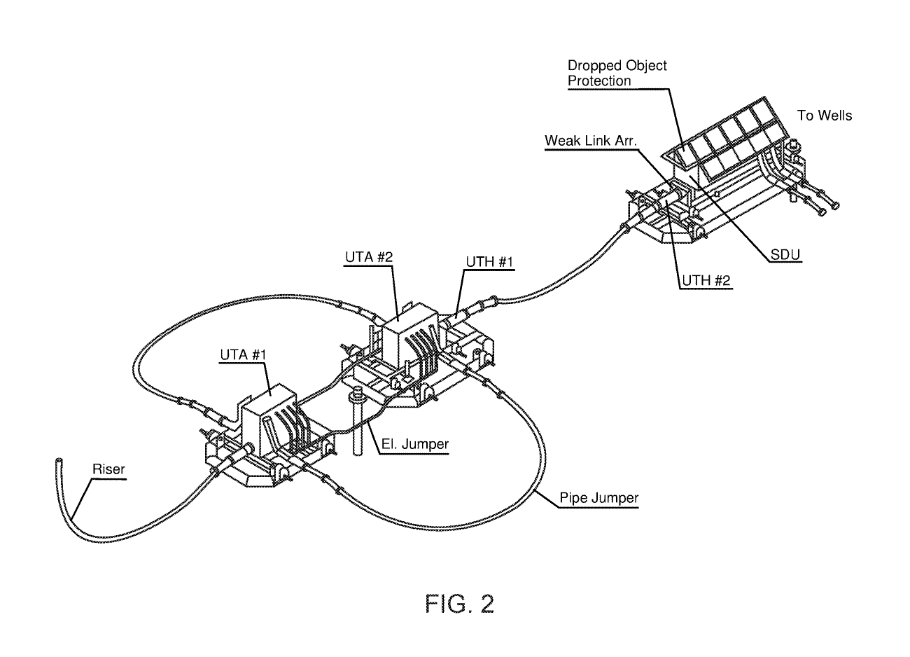

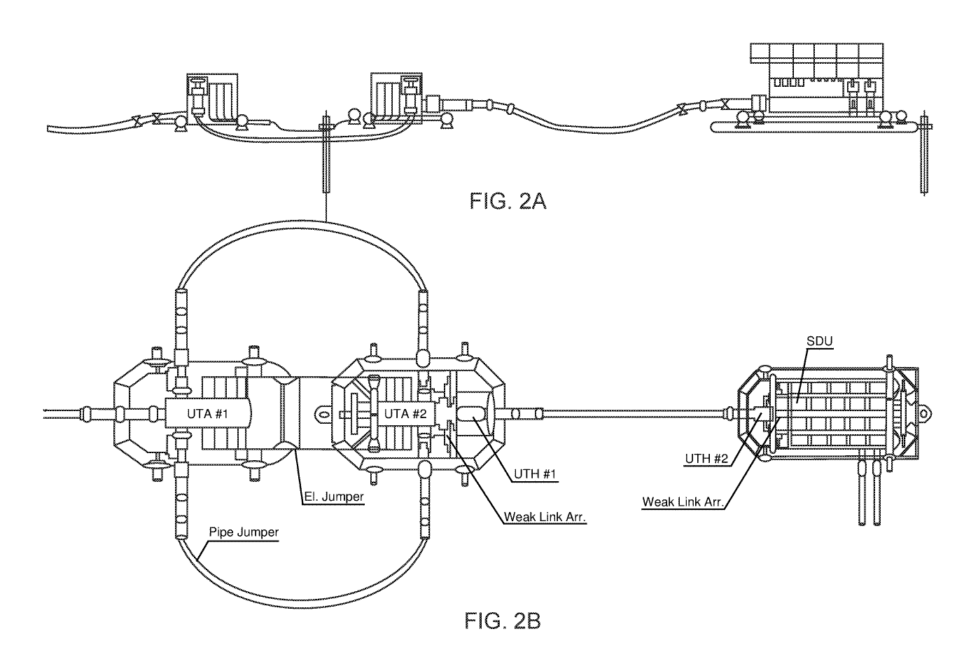

In FIG. 1 and FIG. 2 there is presented two variations of the same concept. The difference between the two is that for the FIG. 1 concept, fewer parts need to be installed. There is no UTA terminated at the subsea end of the riser tube section of the umbilical, and as a consequence, there is no need for flying leads. The optimal solution will depend on the retrieval philosophy for the riser tube section of the umbilical.

A potential re-installation of a new umbilical with the weak link arrangement after a disruption has taken place, can be performed.

### THE INVENTION

According the present invention, a weak link arrangement of the introductory said kind is provided, which is distinguished in that the weak link arrangement includes a seabed frame supporting an umbilical having a weak link multiconnecting structure (UTA) installed in line, which weak link multiconnecting structure (UTA) ensures continuous communication through the fluid pipes and electric cables until emergency disconnection takes place, which disconnection is initiated by accidental pull in the umbilical, which pull activates disconnecting means and cable severing means. The severing means may also be able to sever the pipes if designed properly, both polymer pipes and steel pipes. The severing means can also severe optical cables if included in the umbilical cross section.

The pull will activate the disconnecting means as a first disconnecting step and the cable severing means as a second disconnecting step.

In one embodiment the disconnecting means includes a shear pin designed to shear off and initiate UTA motion at a predetermined pull force in the umbilical, which shear pin is arranged between the weak link multiconnecting structure (UTA) and the seabed frame, which seabed frame further includes a bar arranged to stop the initiated motion, which stop initiates the first disconnecting step.

Further, the disconnecting means can include a connector, which connector is designed to be released and initiated when the UTA is engaging the stop.

The connector can be a clamp connector kept locked by means of a release handle being locked to a release arm arranged on the seabed frame until the motion between the weak link multiconnecting structure and the seabed frame is stopped while the pull in the umbilical continues.

The release arm may arrest the release handle in a notch until a motion between the umbilical (including the connector) and the weak link multiconnecting structure (which is now stopped) takes place. This motion brings the release handle out of the notch and releases the clamp connector and just falls off.

The weak link multiconnecting structure may include an UTA casing enclosing the cable severing means, and in which casing the cables are looped and trapped in cable guiding means.

The cable severing means may include respective knife edges arranged in an array, each knife edge being dedicated for one respective cable, each cable being forcedly guided by the cable guiding means towards a respective knife edge, which cable severing means is being operated by further pull in the umbilical and further motion between the umbilical and the stopped weak link multiconnecting structure (UTA), which further pull initiates the second disconnecting step.

The weak link multiconnecting structure (UTA) can be arranged on a sledge structure able to skid on the seabed frame.

Also a method for making governed and controlled emergency disconnect between an umbilical cable and subsea equipment located on the seabed, is provided, which method includes, when a pull in the umbilical occurs, a weak link multiconnecting structure (UTA) and the umbilical start moving and shear pins shear off, initiating a two step disconnect procedure as described in claim 1-9.

### EXAMPLE OF EMBODIMENT

Having described the invention in general terms above, a more detailed example of an embodiment will be given in the following with reference to the drawings in which:

FIG. 1 is a perspective view of a typical layout of a weak link arrangement according to the present invention;

FIG. 1A is an elevation view of the arrangement according to FIG. 1,

FIG. 1B is a top view of the arrangement according to FIG. 1,

FIG. 2 is a typical layout of a prior art weak link arrangement,

FIG. 2A is an elevation view of the arrangement according to FIG. 2,

FIG. 2B is a top view of the arrangement according to FIG. 2,

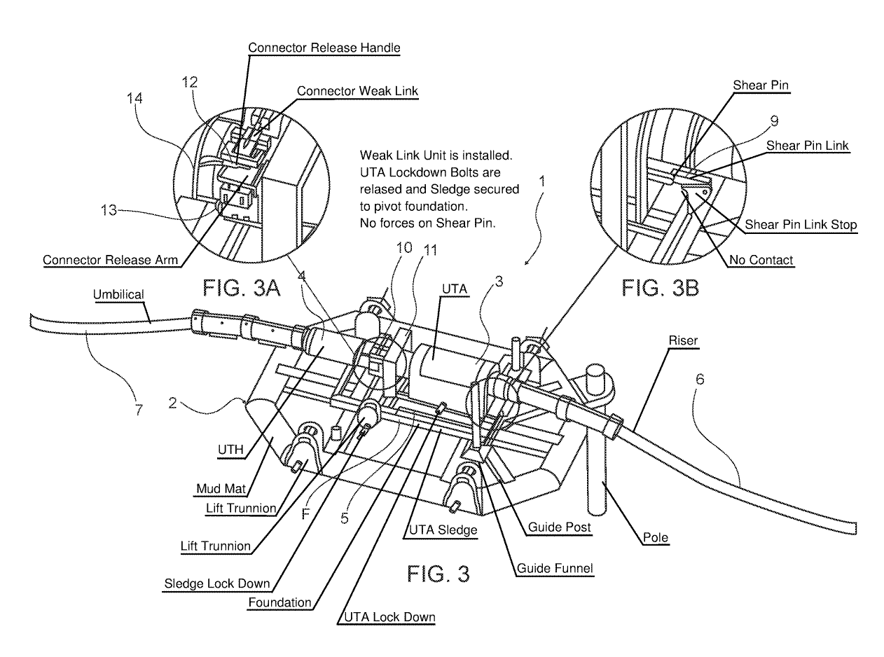

FIG. 3 is a close up perspective view of the weak link arrangement of FIG. 1, and in a first release sequence,

FIG. 3A is an enlarged detail of part of the disconnecting means,

FIG. 3B is an enlarged detail of another part of the disconnecting means,

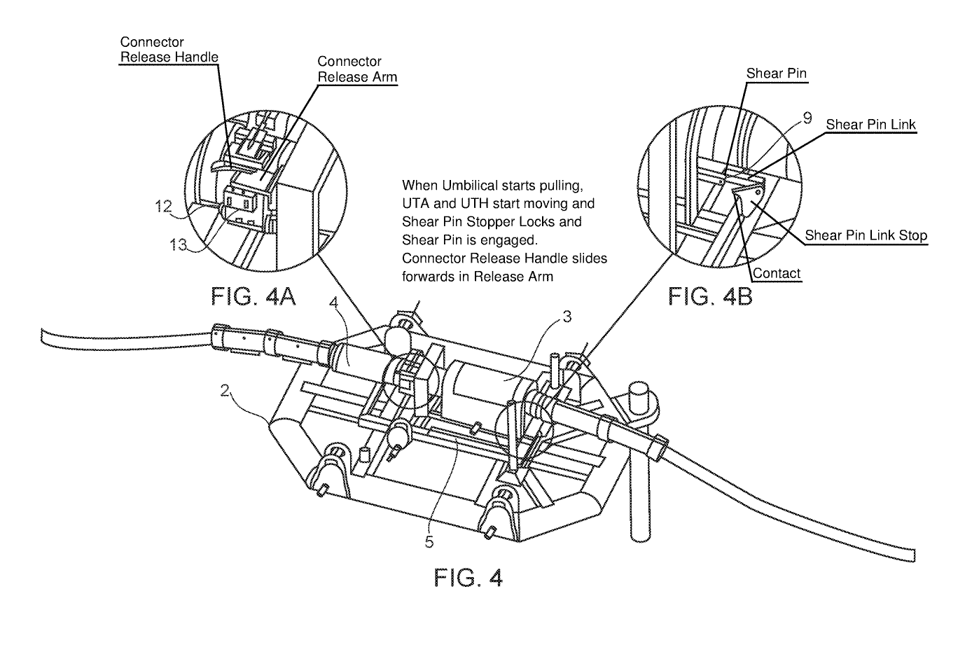

FIG. 4 is a close up perspective view of the weak link arrangement of FIG. 1, and in a second release sequence,

FIG. 4A is an enlarged detail of part of the disconnecting means,

FIG. 4B is an enlarged detail of another part of the disconnecting means,

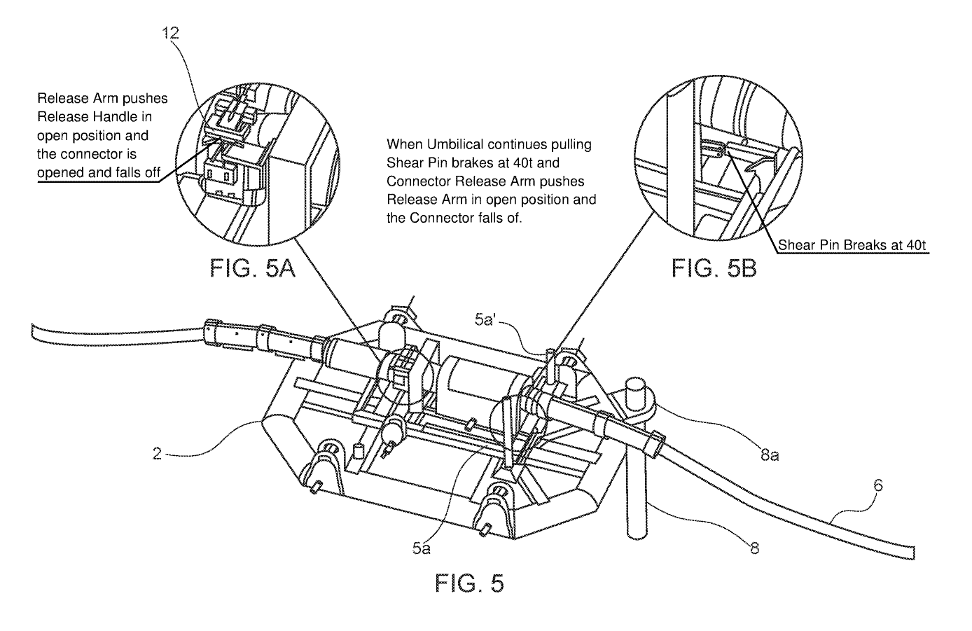

FIG. 5 is a close up perspective view of the weak link arrangement of FIG. 1, and in a third release sequence,

FIG. 5A is an enlarged detail of part of the disconnecting means,

FIG. 5B is an enlarged detail of another part of the disconnecting means,

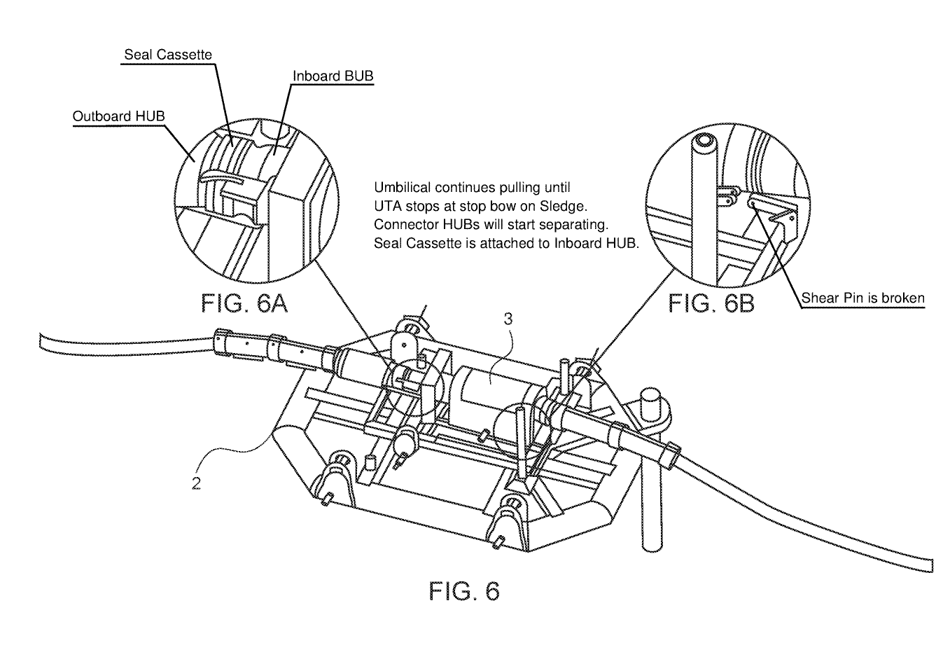

FIG. 6 is a close up perspective view of the weak link arrangement of FIG. 1, and in a fourth release sequence,

FIG. 6A is an enlarged detail of part of the disconnecting means,

FIG. 6B is an enlarged detail of another part of the disconnecting means,

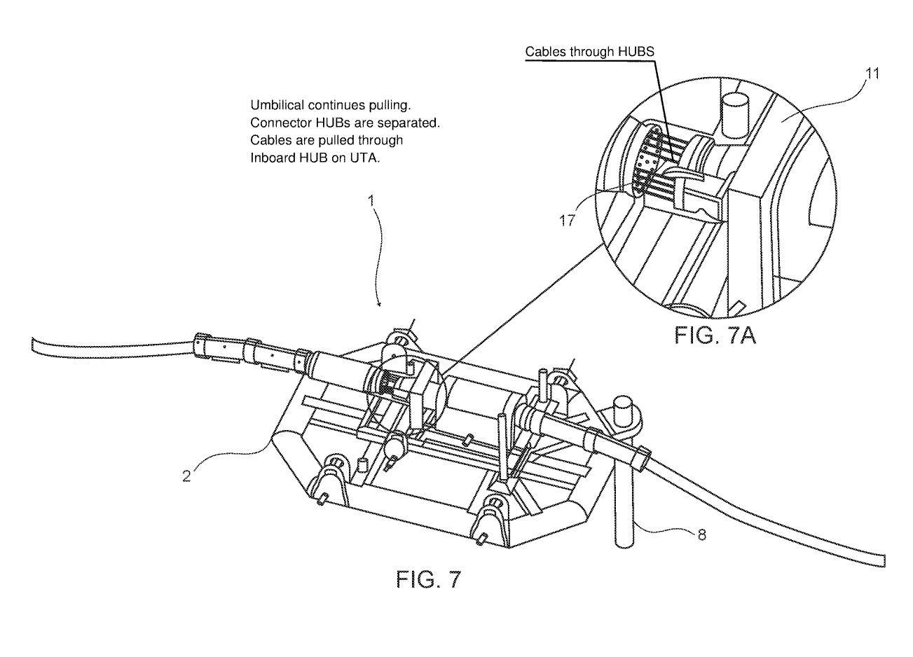

FIG. 7 is a close up perspective view of the weak link arrangement of FIG. 1, and in a fifth release sequence,

FIG. 7A is an enlarged detail of part of the disconnecting means,

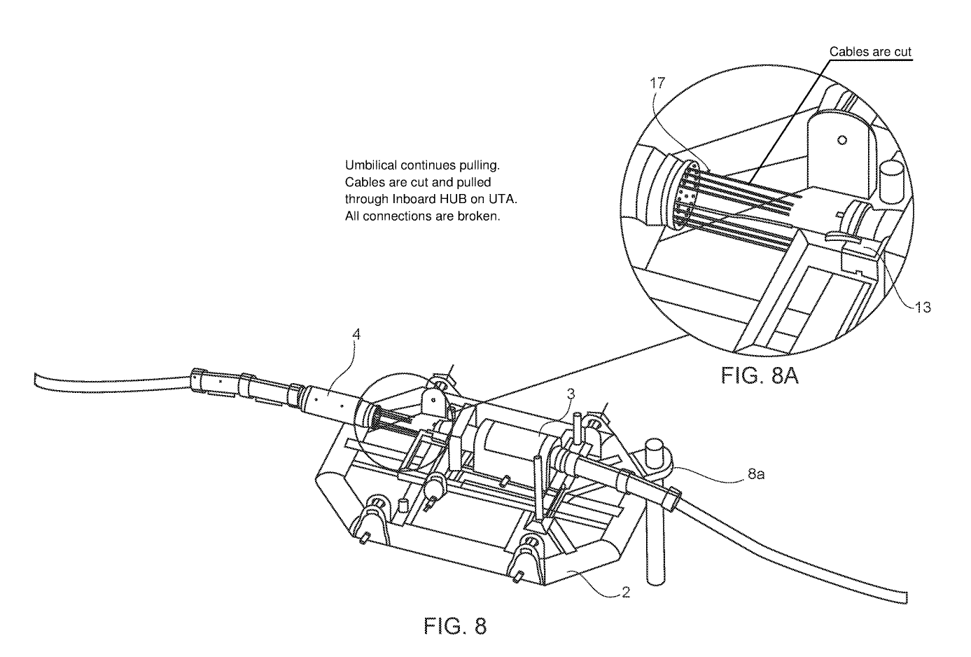

FIG. 8 is a close up perspective view of the weak link arrangement of FIG. 1, and in a sixth release sequence,

FIG. 8A is an enlarged detail of part of the disconnecting means,

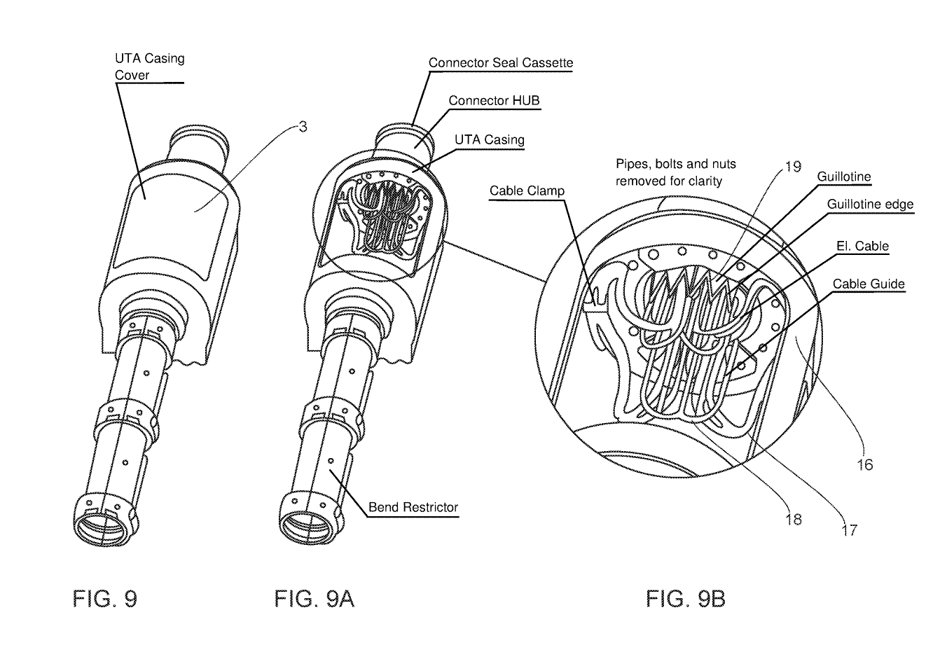

FIG. 9 is a close up perspective view of the weak link multiconnecting structure UTA,

FIG. 9A is similar to FIG. 9, but with a cover removed to show the internals,

FIG. 9B is an enlarged detail of the FIG. 9A casing,

FIGS. 10 and 10A are close up perspective views of the weak link arrangement of FIG. 1, indicating possible turning of the sledge structure,

FIG. 10B is an enlarged top view of FIG. 10,

FIG. 10C is an enlarged top view of FIG. 10A,

FIG. 10D is an enlarged elevational view of FIG. 10 and with sectioned portions,

FIG. 11 illustrates a first sequence for reinstallation of an UTA onto a seabed frame structure,

FIG. 11A is a frontal view of the FIG. 11 view,

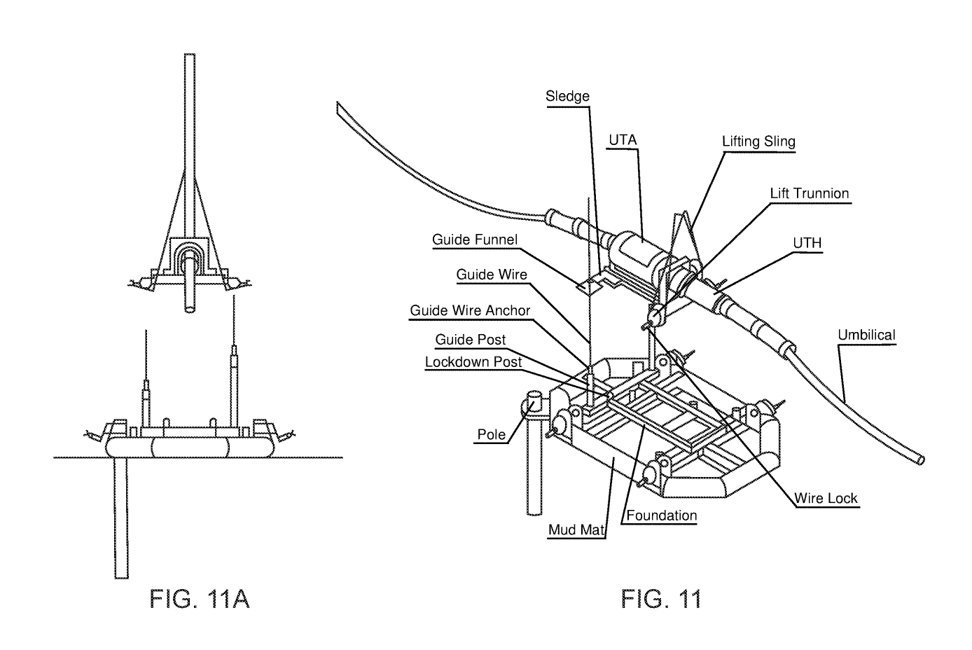

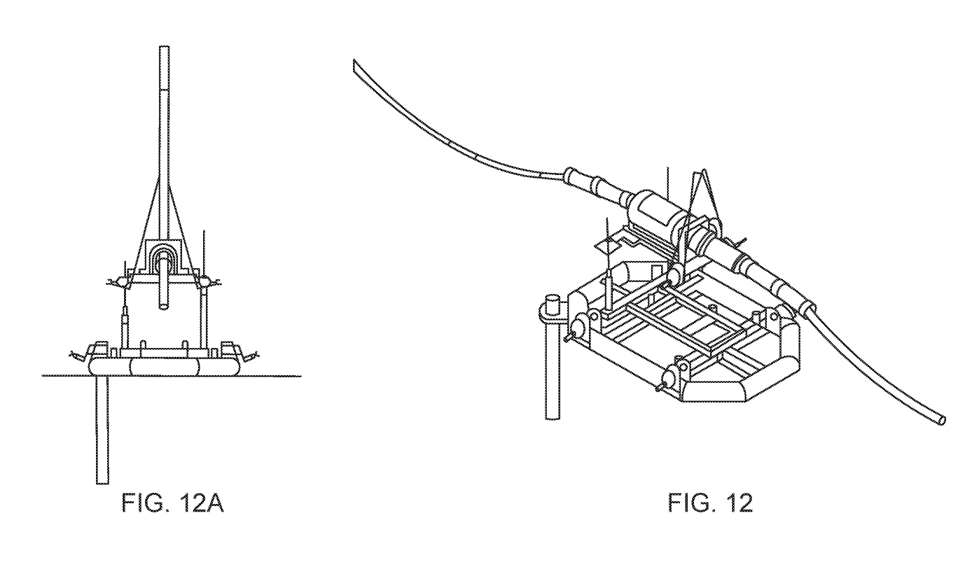

FIG. 12 illustrates a second sequence for reinstallation of an UTA onto a seabed frame structure,

FIG. 12A is a frontal view of the FIG. 12 view,

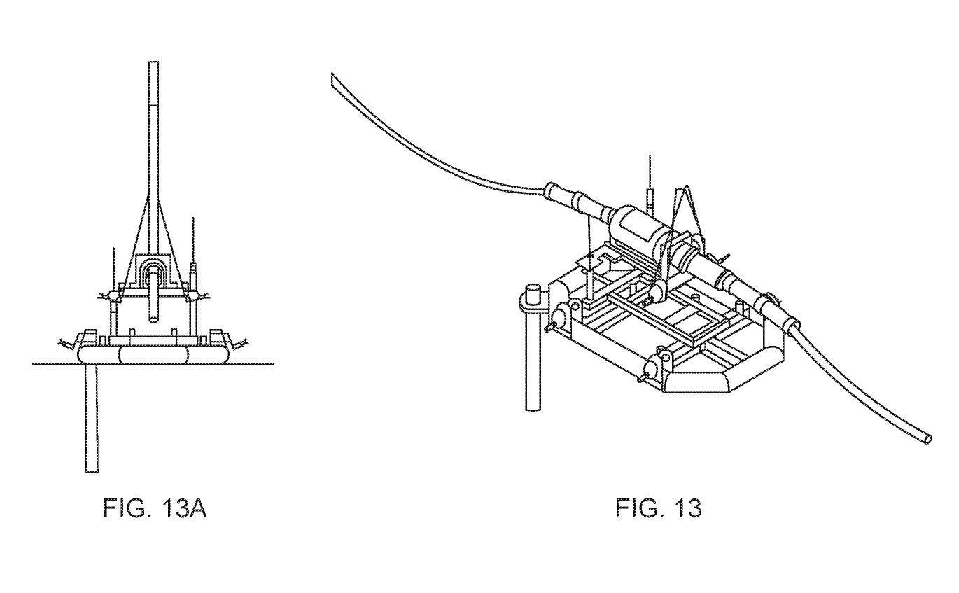

FIG. 13 illustrates a third sequence for reinstallation of an UTA onto a seabed frame structure,

FIG. 13A is a frontal view of the FIG. 13 view,

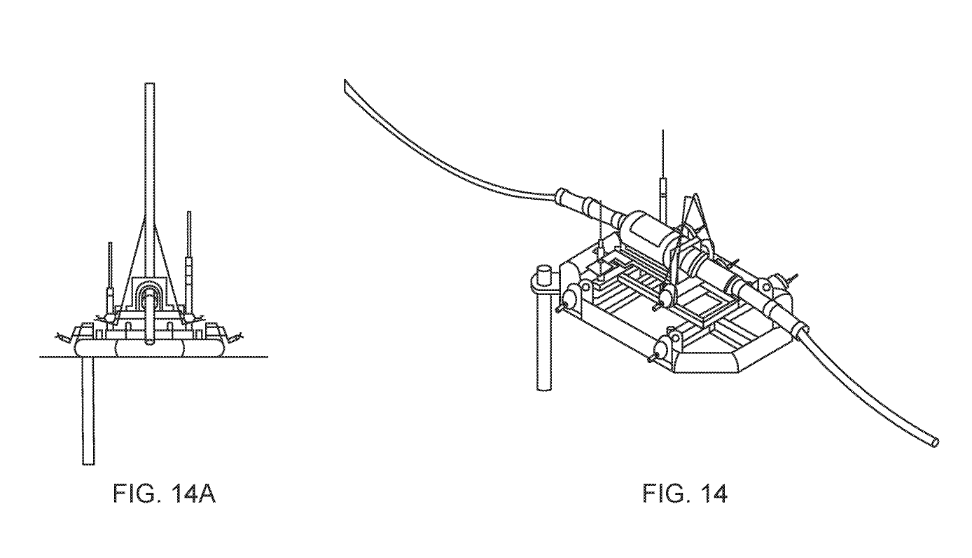

FIG. 14 illustrates a fourth sequence for reinstallation of an UTA onto a seabed frame structure,

FIG. 14A is a frontal view of the FIG. 14 view,

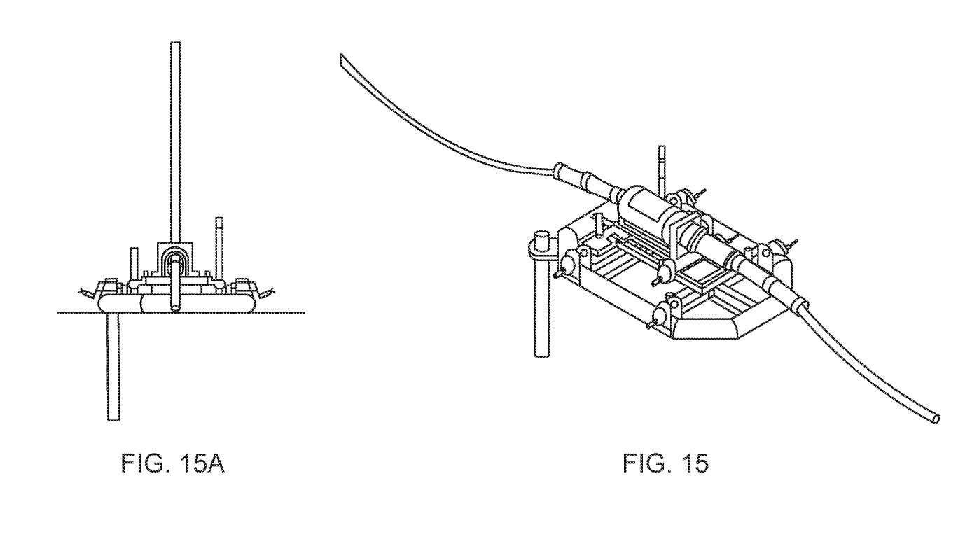

FIG. 15 illustrates a fifth sequence for reinstallation of an UTA onto a seabed frame structure,

FIG. 15A is a frontal view of the FIG. 15 view.

The weak link arrangement will now be described in further details with reference to FIG. 1-10.

FIG. 1 shows a typical layout of a weak link arrangement 1 located on the seabed. The weak link arrangement includes a seabed frame 2 supporting a weak link multiconnecting structure 3 (UTA—Umbilical Termination Assembly) and an umbilical termination unit 4 (UTH—Umbilical Termination Head). The weak link multiconnecting structure 3 and the umbilical termination unit 4 are supported in a sledge structure 5. The sledge structure 5 is allowed to move relative to the seabed frame 2, though in a restricted motion. A motion of the sledge structure 5 will be necessary to put the weak link arrangement in operation. However, the best is that such motion never finds place.

The weak link multiconnecting structure 3 is in one end connected to a riser umbilical 6 extending to the surface. In the other end of the weak link multiconnecting structure 3, the umbilical termination unit 4 is connected, which unit 4 is in turn connected to a jumper umbilical 7 extending to a second weak link arrangement 8′ located on an SDU (Subsea Distribution Unit). Each umbilical end can be reinforced with bend restrictors.

The weak link arrangement 1 is lowered to the seabed with the riser umbilical 6 connected in one end and the jumper umbilical 7 connected in the other end as a “package”. As shown in FIG. 1, a pole 8 is present. The pole 8 is driven down into the seabed before the weak link arrangement 1 is lowered towards the seabed. An “eye” 2a is arranged on the seabed frame 2. When the weak link arrangement 1 approaches the seabed, the eye 2a enters the pole 8 and is thereby arrested on its location. The pole 8 acts as a secure anchor and demobilize the seabed frame 2.

The respective umbilicals 6, 7 include communicating fluid pipes and electric cables. The fluid pipes can be steel pipes or fluid pipes made of a polymer material. All kind of conceivable electric cables are possible. Another option or addition are fiber optic cables. The weak link arrangement ensures that such communications continue through the fluid pipes and the electric cables until an emergency disconnection situation occur. Such disconnection, as previously indicated, is initiated by accidental pull in either umbilical. Such pull activates the weak link arrangement including disconnecting means and cable and pipe severing means.

The described “pull” will first activate the disconnecting means as a first disconnecting step. The cable severing means will take place as a second disconnecting step.

FIG. 1A and 1B shows a side view and a top view of the FIG. 1 arrangement.

FIG. 2 and FIG. 2A and 2B shows a typical layout of a prior art weak link arrangement.

FIG. 3 shows in closer detail the weak link arrangement 1 ready installed on the seabed. The UTA 3 is initially locked by bolts to the supporting frame 2 in order to be safely lowered and deployed on the seabed. After correct location on the seabed is obtained, a set of UTA lockdown bolts are released and the sledge structure 5 is secured to a pivot foundation F enabling the entire UTA to pivot in the horizontal plane relative to the seabed frame 2.

As shown in closer detail in FIG. 3B, the disconnecting means includes a shear pin 9 designed to shear off at a predetermined load, for example 40 tonnes (this value is only an example and will vary according to the particular application). In the FIG. 3 situation, there is still no forces or loads on the shear pin 9.

In FIG. 4, a pull has been put on the umbilical 7, which initiate motion in the UTA 3 and the UTH 4. This in turn activates a shear pin stopper to lock and engages the shear pin as shown in FIG. 4B. As shown in FIG. 4A the connector release handle 12 slides forwards in release arm 13.

As shown in FIGS. 3, 4 and 5, and in closer detail in FIGS. 3A, 4A and 5A, the disconnecting means further includes a connector 10. The connector 10 is designed to be released when the UTA is engaging a stopping bar 11 arranged as a stop bow on the sledge structure 5. As mentioned, the UTA 3 is set in motion after a certain pull force is reached in the umbilical. The shear pin 9 arranged between the UTA and the seabed frame 2, is sheared off. The connector release arm 13 pushes the release handle 12 into open position and the entire connector 10 falls off, as shown in FIG. 6. This sequence of events constitute the first disconnecting step. FIG. 6B shows the broken shear pin 9 and FIG. 6A shows the naked inboard hub and outboard hub with a seal cassette 20 therebetween.

As shown in the figures, the connector 10 is a clamp connector being locked by means of the release handle 12 being locked to the release arm 13 arranged on the seabed frame 2 until the motion between the UTA 3 and the seabed frame 2 is stopped while the pull in the umbilical continues.

In more detail, the release arm 13 is arresting the release handle 12 in a notch 14 until the motion between the umbilical with the connector 10 and the UTA 3, which is stopped, takes place. This motion brings the release handle 12 out of the notch 14 and releases the clamp connector 10, while the entire connector 10 including the release handle 12 simply falls off.

FIG. 7 shows the situation when the pull in the umbilical continues. This further pull separates the hubs and at this point the fluid pipe communication is disrupted. The cables are still in communication but stretched between the hubs as indicated clearly in FIG. 7A.

FIG. 8 shows the situation when the pull in the umbilical still continues and the hubs are brought a further distance apart. The cables has been cut off and pulled through the inboard hub on UTA 3. All connections are then broken and the second disconnecting step has been performed.

As indicated and shown in FIGS. 9, 9A and 9B, the weak link multiconnecting structure 3 includes an UTA casing 16 enclosing the cable severing means, and in which casing the respective cables 17 are looped and clamped in addition to being trapped in cable guiding means 18.

As shown in more detail in FIG. 9B, the cable severing means includes respective knife edges 19 arranged in an array, where each knife edge 19 is being dedicated for one respective cable 17. Each cable 17 is forcedly guided by the cable guiding means 18 towards a respective knife edge 19. The cable severing means is simply operated by further pull in the umbilical and further motion between the umbilical and the stopped weak link multiconnecting structure 3. As mentioned, this further pull initiates the second disconnecting step. It is to be noted that the knifes also can be used to sever optical fibres and polymer fluid pipes, in fact also if they are made of steel and the knifes are adapted to such use.

The weak link multiconnecting structure (UTA) is arranged on the sledge structure 5 and able to skid and pivot on the seabed frame 2, as more detailed shown in FIG. 10 to FIG. 10D. The sledge structure 5 is, as an example only, here allowed to pivot about 30 degrees in the horizontal plane in order to be able to adapt to the direction of a potential pull in the umbilical 7. As shown in FIG. 10D, one turning post 5b is acting as pivot axis (substantially vertical) for such pivotal motion.

FIG. 11-15 illustrates five sequences for reinstallation of an UTA onto a seabed frame structure. If an accident has happened, such reinstallation is prepared for and may take place as illustrated in FIG. 11 to 15.

Also a method for making governed and controlled emergency disconnect between an umbilical cable and subsea equipment located on the seabed, is disclosed. When a pull in the umbilical occurs, a weak link multiconnecting structure (UTA) and the umbilical start moving and shear pins shear off, initiating a two step disconnect procedure as described in claim 1-9.

1. A weak link arrangement designed for location on an umbilical extending on the seabed between respective structures potentially subjected to environmental hazards, which umbilical includes communicating fluid pipes and electric cables, the weak link arrangement includes a seabed frame supporting an umbilical having a weak link multiconnecting structure (UTA) installed in line, which weak link multiconnecting structure (UTA) ensures continuous communication through the fluid pipes and electric cables until emergency disconnection takes place, which disconnection is initiated by accidental pull in the umbilical, which pull activates disconnecting means and cable severing means, the pull activates the disconnecting means as a first disconnecting step and the cable severing means as a second disconnecting step, wherein the disconnecting means includes a shear pin designed to shear off and initiate UTA motion at a predetermined pull force in the umbilical, which shear pin is arranged between the weak link multiconnecting structure (UTA) and the seabed frame, which seabed frame further includes a bar arranged to stop the initiated motion, which stop initiates the first disconnecting step.

2. The weak link arrangement according to claim 1, wherein the disconnecting means includes a connector, which connector is designed to be released and initiated when the UTA is engaging the stop.

3. The weak link arrangement according to claim 2, wherein the connector is a clamp connector kept locked via a release handle being locked to a release arm arranged on the seabed frame until the motion between the weak link multiconnecting structure and the seabed frame is stopped while the pull in the umbilical continues.

4. The weak link arrangement according to claim 4, wherein the release arm is arresting said the release handle in a notch until a motion between the umbilical with the connector and the weak link multiconnecting structure, which is stopped, takes place, which motion brings the release handle out of the notch and releases the clamp connector, which connector falls off.

5. The weak link arrangement according to claim 1, wherein the weak link multiconnecting structure includes an UTA casing enclosing the cable severing means, and in which casing the cables are looped and trapped in cable guiding means.

6. The weak link arrangement according to claim 1, wherein the cable severing means includes respective knife edges arranged in an array, each knife edge being dedicated for one respective cable, each cable being forcedly guided by the cable guiding means towards a respective knife edge, which cable severing means is being operated by further pull in the umbilical and further motion between the umbilical and the stopped weak link multiconnecting structure (UTA), which further pull initiates the second disconnecting step.

7. The weak link arrangement according to claim 1, wherein the weak link multiconnecting structure (UTA) is arranged on a sledge structure able to skid on the seabed frame.

8. A method for making governed and controlled emergency disconnect between an umbilical cable and subsea equipment located on the seabed, wherein, when a pull in the umbilical occurs, a weak link multiconnecting structure (UTA) and the umbilical start moving and shear pins shear off, initiating a two step disconnect procedure as described in claim 1.
